(19) United States
(12) Patent Application Publication
(10) Pub. No.: US 2015/0172827 A1
(43) Pub. Date: Jun. 18, 2015

(54) IDENTITY CONFIRMATION USING WEARABLE COMPUTERIZED EARPIECES AND RELATED METHODS

(71) Applicant: United Sciences, LLC, Atlanta, GA (US)

(72) Inventors: WESS ERIC SHARPE, VININGS, GA (US); KAROL HATZILIAS, ATLANTA, GA (US)

(21) Appl. No.: 14/109,555

(22) Filed: Dec. 17, 2013

(51) Int. Cl. H04R 25/00; G06F 21/31

(52) U.S. Cl. CPC H04R 25/00; G06F 21/31

(57) ABSTRACT

A customized wearable computerized earpiece, according to various embodiments is configured to confirm an identity of an individual. The earpiece may include a housing that is customized to fit within the individual's ear (e.g., ear canal). The earpiece may include one or more sensors configured to sense whether the earpiece is positioned within the ear of the individual. The one or more sensors may, for example, include one or more pressure sensors, one or more bio-electrical impedance sensors, one or more orientation sensors, one or more accelerometers, one or more oxygen sensors, one or more brainwave sensors, one or more heart rate sensors, or any other suitable sensor.

### BACKGROUND

Many software programs require each user to enter unique identifying information (e.g., a username and password) in order to access certain functionality. Some computerized hardware devices (e.g., door locks) also require a user to identify themselves (e.g., using a code) to trigger certain behavior of the hardware, such as unlocking a door. One difficulty associated with current security techniques is that each user may have a unique username/password combination for tens, if not hundreds, of different computer programs, web sites, and devices.

Accordingly, the user is faced with a dilemma. As one option, they can commit all of their unique username/password combinations to memory. However, this can be overwhelming if the user follows the recommended practice of having a unique username and password for every program/device that they use. As a second option, they can maintain a list of all of their various usernames and passwords. However, this can render the user vulnerable to security breaches if someone other than the user obtains access to the list. As a third option, the user can use the same one or two username/password combinations for all of their different computer programs and devices. This again can result in unauthorized access to the user's programs and devices if, for example, the username/password combination is obtained by a third party (e.g., through common phishing techniques). In light of the above, there is currently a need for a method or apparatus that would allow users to conveniently and securely gain access to products that require the identification of the user for access.

### SUMMARY

A wearable computerized earpiece is adapted to identify a user based the unique shape of one or more portions of the user's ear and, in response to confirming the identity of the individual, to communicate a confirmation of the user's identity to a computer, such as a remote computer, via any suitable communication methodology (e.g., via a suitable wireless communication system, such as Bluetooth) In various embodiments, the earpiece comprises a housing that has been customized to fit at least partially into a particular ear of a particular individual so that an outer portion of the housing at least substantially conforms to a shape of an interior portion of the individual's ear and at least one sensor. In particular embodiments, the at least one sensor is disposed adjacent the housing and is adapted to sense whether the housing is operatively positioned within the particular ear of the particular individual.

A method of confirming an identity of a particular individual, according to various embodiments, comprises: (1) scanning at least a portion of a first ear canal of the individual to create a digital impression of the first ear canal; (2) using the digital impression to create a customized earpiece for use in identifying an individual based on a unique shape of the individual's first ear canal, the customized earpiece including one or more sensors that are configured for use in determining whether the customized earpiece is properly fit within the first ear canal of the particular individual; (3) receiving a first set of benchmark sensor data comprising at least one reading for at least one of the one or more sensors, each of the readings having been obtained when the customized earpiece was operatively positioned within the ear canal; (4) receiving a second set of sensor data comprising at least one reading for at least one of the one or more sensors taken at a particular time; (5) comparing the second set of sensor data with the first set of benchmark sensor data; and (6) in response to determining that the second set of sensor data at least substantially corresponds to the first set of benchmark sensor data, confirming that the individual who was wearing the custom earpiece at the particular time is the particular individual.

A non-transitory computer readable medium, according to various embodiments, stores computer-executable instructions for: (1) receiving a first set of data that corresponds to the respective readings of each of a plurality of sensors that are associated with a custom earpiece that has been customized so that at least a particular portion of the custom earpiece conforms with at least a portion of an ear canal of a first ear of a particular individual, each of the respective readings being a reading of a particular one of the plurality of sensors when the custom earpiece is operatively positioned within the ear canal of the first ear of the particular individual; (2) receiving a second set of data that corresponds to a respective reading of each of the plurality of sensors at a particular time; (3) comparing the second set of data to the first set of data; and (4) in response to determining that the second set of data at least substantially corresponds to the first set of data, confirming that the individual who was wearing the custom earpiece at the particular time is the particular individual.

### BRIEF DESCRIPTION OF THE DRAWINGS

Reference will now be made to the accompanying drawings, which are not necessarily drawn to scale, and wherein:

FIG. 1 shows a block diagram of an Identity Confirmation System according to one embodiment;

FIG. 2 shows a block diagram of the remote computing device of FIG. 1;

FIG. 3 shows a flow diagram that depicts steps executed by an exemplary Customized Wearable Computerized Earpiece Creation Module; and

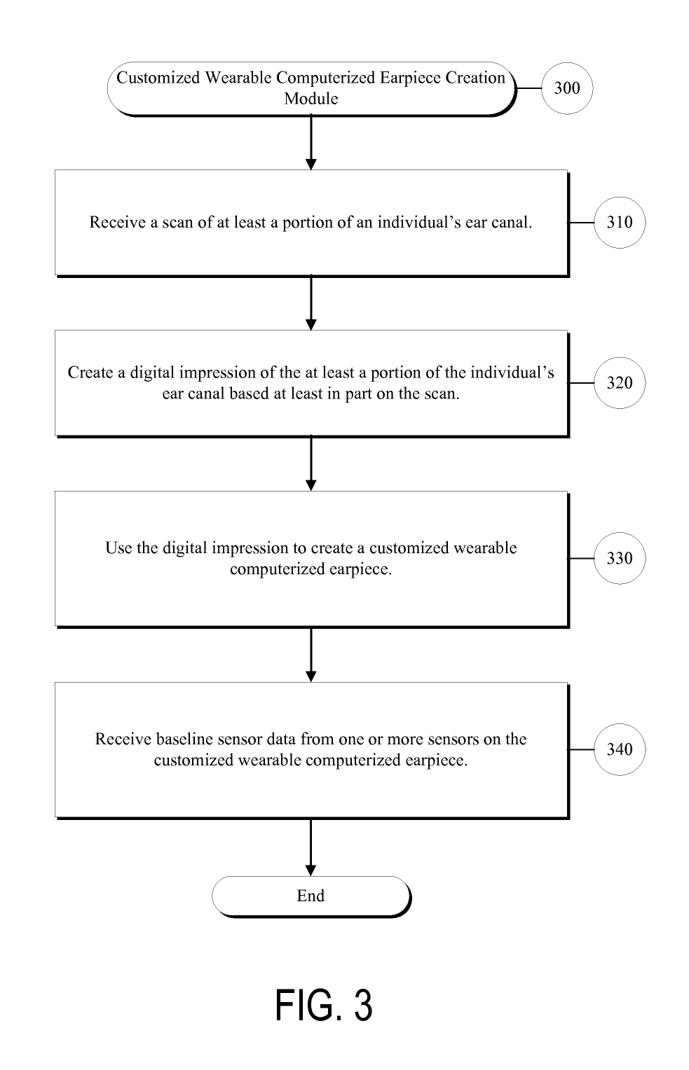

FIG. 4 shows a flow diagram that depicts steps executed by an exemplary Identity Confirmation Module.

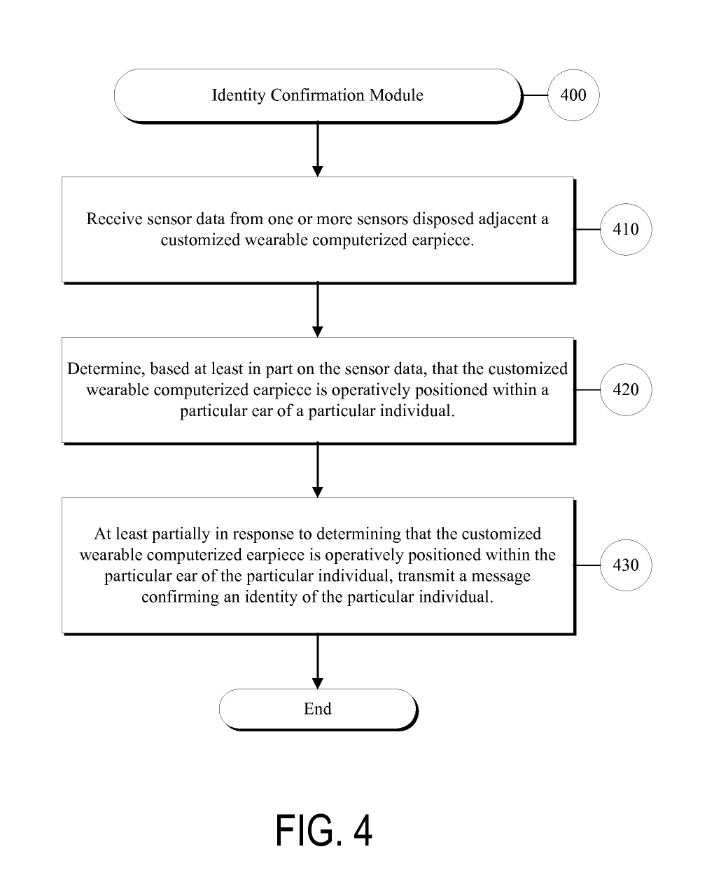

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A wearable computerized earpiece according to various embodiments is adapted to: (A) identify a user based the unique shape of one or more portions of the user's ear; and (B) in response to confirming the user's identity, communicate a confirmation of the user's identity to a computer, such as a remote computer, via any suitable communication methodology (e.g., via a suitable wireless communication system, such as Bluetooth). The computerized earpiece may identify the user, for example, based on whether at least a portion of the earpiece fits properly within a user's ear when the earpiece is operably positioned adjacent (e.g., in) the user's ear canal. In particular embodiments, the earpiece may include one or more sensors (e.g., pressure sensors, photo sensors, or cameras) that are adapted to assess whether the earpiece properly (e.g., snuggly) fits a portion of the user's ear. In various embodiments, the one or more sensors may make this determination by detecting whether a portion of the earpiece's exterior at least substantially conforms to (e.g., mates with) a corresponding interior portion of the individual's ear when the earpiece is operably positioned adjacent the individual's ear canal.

In various embodiments, a unique method is used to create one or more customized wearable computerized earpieces for a particular individual. The system may create a customized earpiece by, for example: (1) scanning at least a portion of a particular ear canal of a particular individual; (2) creating a digital impression of the individual's ear canal from the scan; and (3) using the digital impression to create the customized earpiece (e.g., by using a 3-D printing process to print at least a portion of the earpiece (e.g., a flexible earpiece housing) from a suitable, flexible material. After the portion of the earpiece is printed, the earpiece may be completed by adding (e.g., manually or automatically) any suitable electronics to the earpiece. This process may be completed for both of the user's ears.

In particular embodiments, the customized wearable computerized earpiece comprises a housing having an outer portion that at least substantially conforms to a shape of an interior portion of the individual's ear (e.g., the individual's ear canal). Because of the customized housing, the customized wearable computerized earpiece is configured to substantially properly fit at least partially within the individual's ear when the individual is wearing the earpiece. Because of the unique shape of different individuals' ear canals, the customized wearable computerized earpiece may not properly fit in the ear of an individual other than the individual for whom the earpiece was customized. Accordingly, such a customized wearable computerized earpiece may be utilized as part of a system for confirming the identity of an individual.

In particular embodiments, the customized wearable computerized earpiece may comprise one or more sensors from which the system may receive sensor data while the particular individual is wearing the earpiece. The system may then be configured to determine, based at least in part on the sensor data, that the particular individual is wearing the earpiece (e.g., by comparing the sensor data to baseline sensor data captured while the individual was wearing the customized wearable computerized earpiece at an earlier time). The one or more sensors may, for example, be configured to sense whether the housing is operatively positioned within the ear of the individual (e.g., as opposed to an ear of another individual). In particular embodiments, the earpiece may be adapted to transmit a confirmation of the user's identity to a remote computer after confirming the user's identity. The remote computer may then use this information to allow the user to access one or more software programs, or to activate a particular hardware device (e.g., unlock or open a door).

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

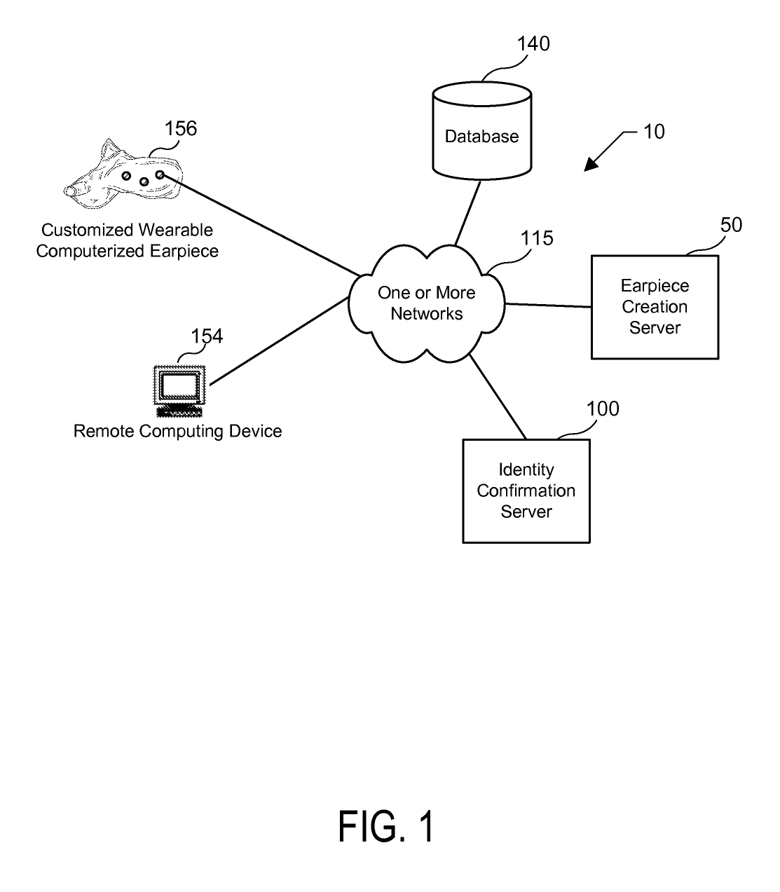

FIG. 1 is a block diagram of a System 10 according to a particular embodiment. As may be understood from this figure, the System 10 includes one or more computer networks 115, an Earpiece Creation Server 50, an Identify Confirmation Server 100, a Database 140, and one or more remote computing devices such as a customized Wearable Computerized Earpiece 156 or a Remote Computing Device 154 (e.g., such as a desktop computer, smartphone, tablet, or other suitable computing device). In particular embodiments, the one or more computer networks facilitate communication between the Earpiece Creation Server 50, Identify Confirmation Server 100, Database 140, and one or more remote computing devices 154, 156.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between Identity Confirmation Server 100 and Database 140 may be, for example, implemented via a Local Area Network (LAN) or via the Internet.

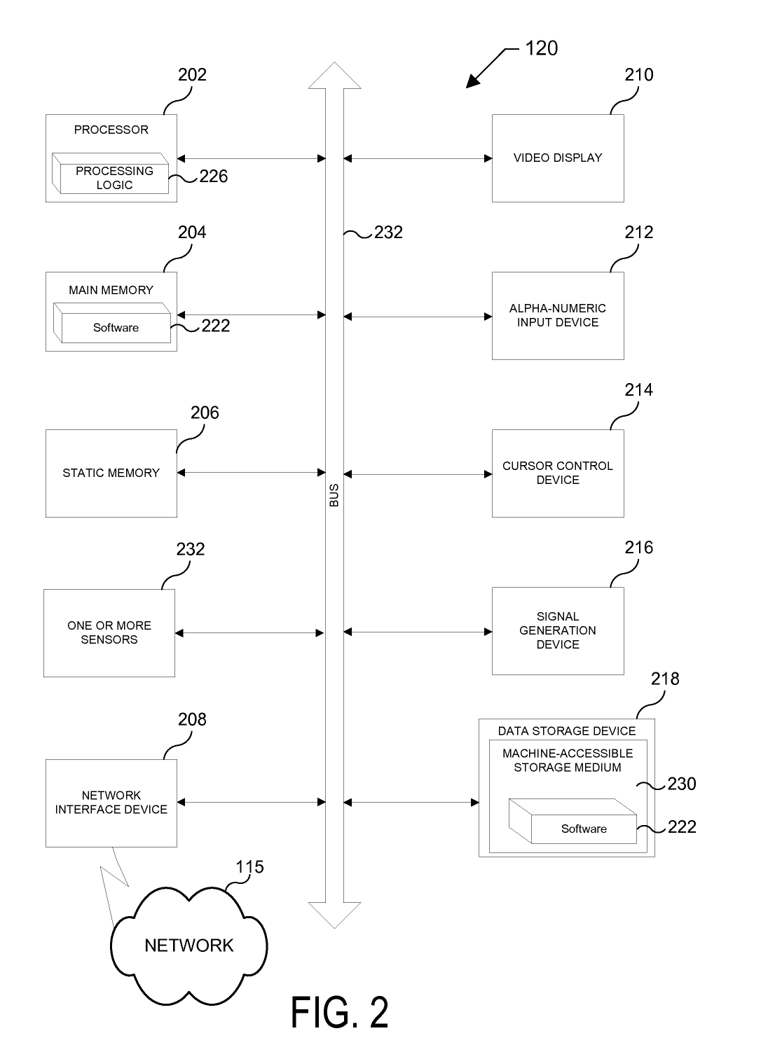

FIG. 2 illustrates a diagrammatic representation of a computer architecture 120 that can be used within the System 10, for example, as a client computer (e.g., one of computing devices 154, 156 shown in FIG. 1), or as a server computer (e.g., Identity Confirmation Server 100 shown in FIG. 1). In particular embodiments, the computer 120 may be suitable for use as a computer within the context of the System 10 that is configured for confirming an identity of an individual wearing the customized wearable computerized earpiece 156.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, a computerized earpiece or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), a signal generation device 216 (e.g., a speaker), and one or more sensors 232 (e.g., one or more pressure sensors, one or more bio-electrical impedance sensors, one or more orientation sensors, one or more accelerometers, one or more oxygen sensors, one or more brainwave sensors, one or more heart rate sensors, or any other suitable sensor.)

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a customized wearable computerized earpiece system may be implemented for use in identifying an individual when the individual is wearing one or more customized wearable computerized earpieces. In various embodiments, the earpieces may be embodied as an in-ear speaker, a hearing aid, a dedicated user authentication device, or any other suitable device. In particular embodiments, the system is configured to create a customized wearable computerized earpiece based at least in part on an optical scan of the individual's ear canal. The system is then configured to utilize various techniques to determine that the individual is wearing the customized wearable computerized earpiece. Various aspects of the systems functionality may be executed by certain system modules, including a Customized Wearable Computerized Earpiece Creation Module 300 and an Identity Confirmation Module 400. These modules are discussed in greater detail below.

Customized Wearable Computerized Earpiece Creation Module

The system, in various embodiments, may be configured to execute a Customized Wearable Computerized Earpiece Creation Module 300 to create a customized wearable computerized earpiece that is customized to at least properly fit within an individual's ear. When executing the Customized Wearable Computerized Earpiece Creation Module 300, the system begins, at Step 310, by receiving a scan of at least a portion of an individual's ear canal. In particular embodiments, the scan may include one or more images of the at least a portion of the individual's ear canal. In various embodiments, the system is configured to receive the scan from a scanner (e.g., a handheld scanner) that is configured to use any suitable scanning technique, any suitable imaging technique, or any other suitable technique to take a three dimensional image of the interior of the individual's ear.

The system continues, at Step 320 by creating a digital impression of the at least a portion of the individual's ear canal based at least in part on the scan. In various embodiments the digital impression comprises a 3D image of the at least a portion of the individual's ear canal. In various embodiments, creating the 3D image derived from an optical scan of the interior of the patient's ear canal can be carried out using methods and systems described in U.S. patent application Ser. Nos. 13/417,649; 13/417,767, 13/586,471; 13/586.411; 13/586,459; 13/546,448; 13/586,448; 13/586,474; 14/040,973, 14/041,943; 14/049,666; 14/049,530; 14/049,687, all incorporated by reference herein in their entirety.

Next, at Step 330, the system uses the digital impression to create at least a portion of a customized wearable computerized earpiece. In various embodiments, the system users the digital impression to create the earpiece using any suitable 3-D printing technique, rapid prototyping technique, manufacturing technique, or other suitable technique. In particular embodiments, the customized wearable computerized earpiece comprises a housing having an outer portion that at least substantially conforms to a shape of an interior portion of the individual's ear (e.g., the at least a portion of the individual's ear canal). In particular embodiments, the housing may be 3D printed using a suitable material such as Silicon and then slipped over a base portion that includes various electrical components that the earpiece comprises (e.g., one or more processors, batteries, speakers, sensors, etc.). In various embodiments, at least a portion of the base may extend at least partially through the housing. For example, in the case of the earpiece comprising an in-ear speaker, the speaker portion may extend at least partially through the housing such that when the individual is wearing the earpiece: (1) the housing is disposed at least partially within their ear canal; (2) the speaker portion is disposed at least partially within their ear canal; and (3) the remainder of the earpiece is disposed adjacent the individual's outer ear. In particular embodiments, the earpiece may comprise any suitable material (e.g., a rigid or flexible material) such as, for example, silicon, plastic, rubber, etc.

In various embodiments, the customized wearable computerized earpiece comprises one or more sensors, which may, for example, include one or more pressure sensors, one or more bio-electrical impedance sensors, one or more orientation sensors, one or more accelerometers, one or more oxygen sensors, one or more brainwave sensors, one or more heart rate sensors, or any other suitable sensor. In various embodiments, the one or more sensors are disposed on an outer portion of the housing. In a particular embodiment, the one or more sensors are orbitally positioned about a circumference of a portion of the earpiece that substantially sits within the individual's ear when the individual is wearing the earpiece. In a specific example, the earpiece housing described above comprises three or more pressure sensors substantially evenly spaced about the circumference of the housing.

The system continues, at Step 340, by receiving baseline sensor data from the one or more sensors on the customized wearable computerized earpiece while the particular individual for whom the earpiece was customized is wearing the earpiece. The system may, for example, receive the sensor data during the individual's initial wearing of the customized wearable computerized earpiece. The baseline sensor data may provide the system with baseline readings with which to compare sensor data taken at a later time in order to confirm an identity of the particular individual when the particular individual is wearing the earpieces. The system may, for example, confirm the individual's identity using the Identity Confirmation Module 400 described more fully below.

### Identity Confirmation Module

As discussed above, the system may be configured to confirm an identity of a particular individual while the particular individual is wearing one or more customized wearable computerized earpieces, for example, using an Identity Confirmation Module 400. When executing the various steps of the Identity Confirmation Module 400 in a particular embodiment, the system begins, at Step 410, by receiving sensor data from one or more sensors disposed adjacent a customized wearable computerized earpiece. In various embodiments, the customized wearable computerized earpiece comprises one or more sensors such as, for example, one or more pressure sensors, one or more bio-electrical impedance sensors, one or more orientation sensors, one or more accelerometers, one or more oxygen sensors, one or more brainwave sensors, one or more heart rate sensors, or any other suitable sensor. In particular embodiments, the system is configured to receive any suitable sensor data from any of these one or more sensors such as, for example, electroencephalography, electromyography, electrooculography, electrocardiography, accelerometry, reflective pulse oximetry, audio, temperature, etc. In still other embodiments, the sensor data may be used to determine, for example, one or more pressure readings, orientation data, positioning data, pulse rate, body temperature, blood oxygen level, rapid eye movement sleep, non-rapid eye movement sleep, snoring, blood pressure, muscle tension, and other values derived from sensor data as may occur to those of skill in the art.

In various embodiments, the system is configured to receive sensor data from two customized wearable computerized earpieces while the earpieces are being worn by a particular individual. In various embodiments, the sensor data may include data associated with a relative position of the two earpieces (e.g., a distance between the earpieces). In particular embodiments, the system is configured to receive the sensor data from the customized wearable computerized earpiece via Bluetooth, low-energy Bluetooth, Near Field Communication or any other suitable protocol.

The system continues, at Step 420, by determining, based at least in part on the sensor data, that the customized wearable computerized earpiece is operatively positioned within a particular ear of a particular individual. In various embodiments, the system is configured to determine that the customized wearable computerized earpiece is operatively positioned within the particular ear of the particular individual by comparing the sensor data to baseline sensor data associated with the particular individual and the earpiece (e.g., the baseline sensor data received at Step 340 of the Customized Wearable Computerized Earpiece Module 300). The system may, for example, compare the sensor data to baseline sensor data that includes a range (e.g., a pressure range), a specific distance (e.g., a distance between two earpieces when properly fitted in a particular individual's ears), or any other suitable metric.

In a particular example, the earpiece may comprise one or more pressure sensors that are configured so that, when the earpiece is operatively positioned within the particular ear, the one or more pressure sensors engage at least a portion of the particular ear (e.g., at least a portion of the particular individual's ear canal). The system is configured to receive an indication of a particular pressure level from the one or more sensors and compare the particular pressure level to a baseline pressure level (or pressure level range). In response to determining that the particular pressure level is within the pressure level range, the system is configured to determine that the earpiece is within the particular ear of the particular individual.

Next, at Step 430, the system, at least partially in response to determining that the customized wearable computerized earpiece is operatively positioned within the particular ear of the particular individual, transmits a message confirming an identity of the particular individual. In various embodiments, the system is configured to transmit the message using any suitable protocol, such as, for example, via Bluetooth, Near Field Communication, low-energy Bluetooth, etc. In particular embodiments, the system is configured to transmit the message confirming the identity of the particular individual to a computing device associated with the individual, for example, to serve as a password required by the computing device or by a website or software application that the user is accessing on the computing device. For example, the system may substantially automatically unlock a user's mobile phone in response to receiving confirmation of the user's identity. In other embodiments, the system may be configured to unlock a door in response to detecting that a particular individual is approaching the door (e.g., using Bluetooth, Near Field Communication, etc.) and receiving confirmation of the particular individual's identity as a person authorized to access whatever room or building is behind the door.

In various embodiments, the system may be configured to transmit confirmation of the individual's identity in response to a request for a password or other identifying information (e.g., when the user is attempting to login to an account using a computing device such as a bank account, e-mail account, or other secure account). In other embodiments, the system may transmit confirmation of the individual's identity as part of a financial transaction in order to provide an additional security level to the financial transaction (e.g., when the user desires to pay for an item with a credit card, the system may transmit confirmation of the individual's identity to a point of sale credit card reader or other device in order to verify that the individual is an authorized user of the card).

### User Experience

In order to utilize a customized wearable computerized earpiece for identification purposes, an individual may need to first be fitted for an ear piece. As may be understood from this disclosure, the user may have their ears scanned, for example, by any suitable provider of customized earpieces. A digital impression of the individual's two ears would then be created from the scan, which would then be used to create the customized wearable computerized earpieces for the individual's two ears. Once the earpieces were completed, the user may place the earpieces in their ears in order to provide the baseline sensor data described above. The baseline sensor data may be received by the system, for example, when the individual is trying on the earpieces for the first time, picking them up from the manufacturer, or at any other suitable time.

Once the system has received and stored the baseline sensor data, the user would be able to proceed to utilize the computerized earpieces for identification by wearing one or both earpieces. When requesting identification of the individual, the system may receive substantially current sensor data while the individual is wearing the earpieces and compare the sensor data to the baseline sensor data. The system would then use the sensor data to determine whether the individual wearing the earpieces was the individual for whom they were customized. In response to confirming the individual's identity, the system may then transmit the confirmation as needed (e.g., to unlock the individual's phone, login to the individual's e-mail account, access the individual's locked office, etc.).

### Illustrative Examples

As a particular example, an individual may travel to a retail store to be fitted for custom in-ear speaker ear buds. At the store, the individual's left and right ear canals are scanned by a technician or other employee of the store. The individual may then leave the store (e.g., to see a movie) while the custom ear buds are being created. Once the ear buds are ready to be picked up, the store may send the individual a notification (e.g., text, e-mail, etc.) so that the individual knows they are ready. After retrieving the completed ear buds, the individual may take the ear buds home, place the earbuds in his ears, and use an application on his mobile phone or other computing device to set up one or more passwords that the ear buds will substantially automatically provide if the user is wearing the ear buds near a computing device that has Bluetooth or other suitable wireless communication activated. The user may also use the application to set up one or more baseline sensor readings that the ear buds will later use to confirm his identity before providing the passwords.

Later, when attempting to access his e-mail on his desktop computer at home, the user may navigate a web browser to his e-mail provider's webpage. In response to an indication that the individual is attempting to access a secure page, the ear buds would then confirm the individual's identity as described above. In this case, for example, the ear buds may be configured to confirm the individual's identity by: (1) confirming that one or more of the earbuds properly fit within the individual's ears; (2) confirming that the left and right ear buds are a particular distance apart from one another, the particular distance having been determined from the baseline sensor readings; and (3) confirming that the individual's current heart rate is substantially similar to a resting heart rate of the individual determined from the baseline sensor readings. In response to making these confirmations, the ear buds may then transmit the password (e.g., via Bluetooth) provided by the user during the set up process above for the e-mail account to the desktop computer. The individual may then access their e-mail account without having to enter their password. In various embodiments, the identity confirmation and password transmission process is substantially seamless and may be substantially imperceptible to the individual as they are accessing their e-mail account.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A wearable computerized earpiece comprising:
a housing that has been customized to fit at least partially into a particular ear of a particular individual so that an outer portion of the housing at least substantially conforms to a shape of an interior portion of the individual's ear; and
at least one sensor, disposed adjacent the housing, that is adapted to sense whether the housing is operatively positioned within the particular ear of the particular individual.

2. The wearable computerized earpiece of claim 1, wherein the at least one sensor comprises a plurality of pressure sensors that are each adapted to engage a different portion of an ear canal of the particular ear when the housing is operatively positioned within the particular ear of the particular individual.

3. The wearable computerized earpiece of claim 1, wherein the wearable computerized earpiece is a device selected from a group consisting of: an in-ear speaker; a hearing aid; and a dedicated user authentication device.

4. The wearable computerized earpiece of claim 1, further comprising at least one processor, wherein the wearable computerized earpiece is configured to:
receive sensor data from the at least one sensor; and
use the sensor data to determine that the housing is operatively positioned within the particular ear of the particular individual.

5. The wearable computerized earpiece of claim 4, wherein the at least one processor is further configured to, in response to determining that the housing is operatively positioned within the particular ear of the particular individual, transmit a message confirming an identity of the particular individual.

6. The wearable computerized earpiece of claim 5, wherein the wearable computerized earpiece is configured to transmit the message via a protocol selected from a group consisting of: Bluetooth, near field communications, and low energy Bluetooth.

7. The wearable computerized earpiece of claim 4, wherein the at least one sensor comprises at least one pressure sensor.

8. The wearable computerized earpiece of claim 4, wherein the at least one sensor comprises at least one bio-electrical impedance sensor.

9. The wearable computerized earpiece of claim 4, wherein:
the housing is a first housing;
the particular ear is a first ear of the particular individual;
the at least one sensor comprises at least one sensor for sensing a distance between the first housing and a housing of a second wearable computerized earpiece that is operatively positioned within a second ear of the individual while the first housing is operatively positioned within the first ear.

10. The wearable computerized earpiece of claim 4, wherein the at least one sensor comprises:
a first pressure sensor that is adapted so that, when the housing is operatively positioned within the particular ear, the first pressure sensor engages a first portion of the particular ear so that the first pressure sensor reads a first benchmark pressure level that is within a first pre-determined range of pressures;
a second pressure sensor that is adapted so that, when the housing is operatively positioned within the particular ear, the second pressure sensor engages a second portion of the particular ear so that the second pressure sensor reads a second benchmark pressure level that is within a second pre-determined range of pressures; and
the wearable computerized earpiece is configured to:
receive an indication of a first particular pressure level from the first pressure sensor;
receive an indication of a second particular pressure level from the second pressure sensor;
determine whether the first particular pressure level is within the first pre-determined range of pressures;
determine whether the second particular pressure level is within the second pre-determined range of pressures; and
in response to determining that the first particular pressure level is within the first pre-determined range of pressures and that the second particular pressure level is within the second pre-determined range of pressures, determine that the housing is operatively positioned within the particular ear of the particular individual.

11. The wearable computerized earpiece of claim 10, wherein:
the at least one sensor further comprises an orientation sensor that is configured to determine an orientation of the wearable computerized earpiece; and
the sensor data comprises orientation data determined by the orientation sensor, the orientation data indicating an orientation of the wearable computerized earpiece.

12. The wearable computerized earpiece of claim 11, wherein the orientation data comprises data regarding an angular orientation of the wearable computerized earpiece.

13. The wearable computerized earpiece of claim 4, wherein the at least one sensor comprises at least one sensor selected from a group consisting of: an oxygen sensor, a brainwave sensor and a heart rate sensor.

14. The wearable computerized earpiece of claim 1, wherein the housing is shaped based at least in part on a 3D optical scan of the interior portion of the particular individual's ear.

15. A method of providing a device for use in confirming an identity of a particular individual, the method comprising:
scanning at least a portion of a first ear canal of the individual to create a digital impression of the first ear canal; and
using the digital impression to create a customized earpiece for use in identifying the individual based on a unique shape of the individual's first ear canal, the customized earpiece including one or more sensors that are configured for use in determining whether the customized earpiece is properly fit within the first ear canal of the particular individual.

16. The method of claim 15, wherein the customized earpiece comprises an in-ear speaker.

17. The method of claim 15, wherein the customized earpiece comprises a hearing aid.

18. The method of claim 15, wherein:
the customized earpiece is a first customized earpiece; and
the method further comprises:
scanning at least a portion of a second ear canal of the individual to create a digital impression of the second ear canal; and
using the digital impression to create a second customized earpiece for use in identifying the individual based on a second unique shape of the individual's second ear canal, the second customized earpiece including one or more sensors that are configured for use in determining whether the second customized earpiece is properly fit within the second ear canal of the particular individual.

19. The method of claim 15, wherein the one or more sensors comprise at least one sensor selected from a group consisting of: a pressure sensor, an accelerometer, a proximity sensor, a temperature sensor, a heart rate sensor, a blood oxygen saturation sensor, and a brain wave sensor.

20. A method of confirming an identity of a particular individual, the method comprising:
scanning at least a portion of a first ear canal of the individual to create a digital impression of the first ear canal;
using the digital impression to create a customized earpiece for use in identifying an individual based on a unique shape of the individual's first ear canal, the customized earpiece including one or more sensors that are configured for use in determining whether the customized earpiece is properly fit within the first ear canal of the particular individual;
receiving a first set of benchmark sensor data comprising at least one reading for at least one of the one or more sensors, each of the readings having been obtained when the customized earpiece was operatively positioned within the ear canal;
receiving a second set of sensor data comprising at least one reading for at least one of the one or more sensors taken at a particular time;
comparing the second set of sensor data with the first set of benchmark sensor data;
in response to determining that the second set of sensor data at least substantially corresponds to the first set of benchmark sensor data, confirming that the individual who was wearing the custom earpiece at the particular time is the particular individual.

21. The method of claim 20, wherein the customized earpiece comprises an in-ear speaker.

22. The method of claim 20, wherein the one or more sensors comprise at least one sensor selected from a group consisting of: a pressure sensor, an accelerometer, a proximity sensor, a temperature sensor, a heart rate sensor, a blood oxygen saturation sensor, and a brain wave sensor.

23. A non-transitory computer readable medium storing computer-executable instructions for:
receiving a first set of data that corresponds to the respective readings of each of a plurality of sensors that are associated with a custom earpiece that has been customized so that at least a particular portion of the custom earpiece conforms with at least a portion of an ear canal of a first ear of a particular individual, each of the respective readings being a reading of a particular one of the plurality of sensors when the custom earpiece is operatively positioned within the ear canal of the first ear of the particular individual;
receiving a second set of data that corresponds to a respective reading of each of the plurality of sensors at a particular time;
comparing the second set of data to the first set of data; and
in response to determining that the second set of data at least substantially corresponds to the first set of data, confirming that the individual who was wearing the custom earpiece at the particular time is the particular individual.

24. The method of claim 23, wherein the customized earpiece comprises an in-ear speaker.

25. The method of claim 23, wherein the one or more sensors comprise at least one sensor selected from a group consisting of: a pressure sensor, an accelerometer, a proximity sensor, a temperature sensor, a heart rate sensor, a blood oxygen saturation sensor, and a brain wave sensor.
